(19) United States
(12) Patent Application Publication
(10) Pub. No.: US 2011/0225127 A1
(43) Pub. Date: Sep. 15, 2011

(54) INVESTMENT PORTFOLIO MANAGEMENT FACILITY

(75) Inventors: Matthew A. Abar, Parker, CO (US); Michael R. Benson, Aurora, CO (US)

(73) Assignee: ABAKOS, INC., Parker, CO (US)

(21) Appl. No.: 13/041,484

(22) Filed: Mar. 7, 2011

Related U.S. Application Data
(60) Provisional application No. 61/313,354, filed on Mar. 12, 2010.

(51) Int. Cl. G06F 17/30

(52) U.S. Cl. 707/691; 707/690; 707/E17.009

(57) ABSTRACT

An investment portfolio management facility is disclosed. The facility is a computerized system for providing data integrity for investment portfolios. When an entry is made, the entry is checked for consistency with previously-made entries and with rules for portfolio entries. If an error is detected, the system alerts users to the error and also provides signals to check for further errors. The user may be made aware of the error or errors through a user interface.

### CROSS-REFERENCE TO RELATED APPLICATIONS

This application claims the benefit of the following U.S. provisional application, which is hereby incorporated by reference in its entirety: U.S. Provisional App. No. 61/313,354 filed Mar. 12, 2010.

### FIELD

The present disclosure relates to financial portfolio management, and more specifically to a computer implemented rule-based financial portfolio management system.

### BACKGROUND

In finance, a portfolio is a mix or collection of investments held by institutions or a private individual. Holding a portfolio is part of an investment and risk-limiting strategy called diversification. By owning several assets, certain types of risk (in particular specific risk) can be reduced. The assets in the portfolio could include stocks, bonds, options, warrants, gold certificates, real estate, futures contracts, production facilities, or any other items that are expected to retain their value. An investment data error could cause monetary impact to an investment portfolio if uncorrected, and wherein there currently are tools for portfolio management, none provides a comprehensive error detection and identification system that provides a user with the needed visibility to ensure the integrity of the portfolio. Therefore a need exists for improved financial portfolio management systems.

### SUMMARY

One embodiment is a computer-implemented system including a program stored on a computer-readable medium. The system includes an event model for an investment portfolio management facility stored as a data structure on a computer-readable medium. The system also includes a rule-based data integrity monitoring module for maintaining investment data integrity for at least one of a plurality of investment portfolios in the investment portfolio management facility, wherein an investment data error found by the data integrity monitoring module would cause monetary impact to the at least one investment portfolio if uncorrected. The system further includes an investment data error alert facility associated with the event model for providing an alert to a user of the investment portfolio management facility when investment data errors are identified by the data integrity monitoring module.

Another embodiment is a method. The method includes steps of providing an event model for an investment portfolio management facility including a rule-based data integrity monitoring module and an investment data error alert facility, maintaining investment data integrity through the data integrity monitoring module for at least one of a plurality of investment portfolios in the investment portfolio management facility, wherein an investment data error found by the data integrity monitoring module would cause monetary impact to the at least one investment portfolio if uncorrected, and providing an alert to a user of the investment portfolio management facility through the investment data alert facility when investment data errors are identified by the data integrity monitoring module.

### BRIEF DESCRIPTION OF THE FIGURES

The following detailed description of certain embodiments may be understood by reference to the following figures:

FIG. 1 depicts a block diagram in an embodiment of the present disclosure.

FIG. 2 illustrates an embodiment of an account list screen.

FIG. 3 illustrates an embodiment of an errors and alerts tool window beneath an account list.

FIG. 4 illustrates an embodiment of an edit bar as shown at the top of an edit screen.

While the present disclosure has been described in connection with certain embodiments, other embodiments would be understood by one of ordinary skill in the art and are encompassed herein.

All documents referenced herein are hereby incorporated by reference.

### DETAILED DESCRIPTION

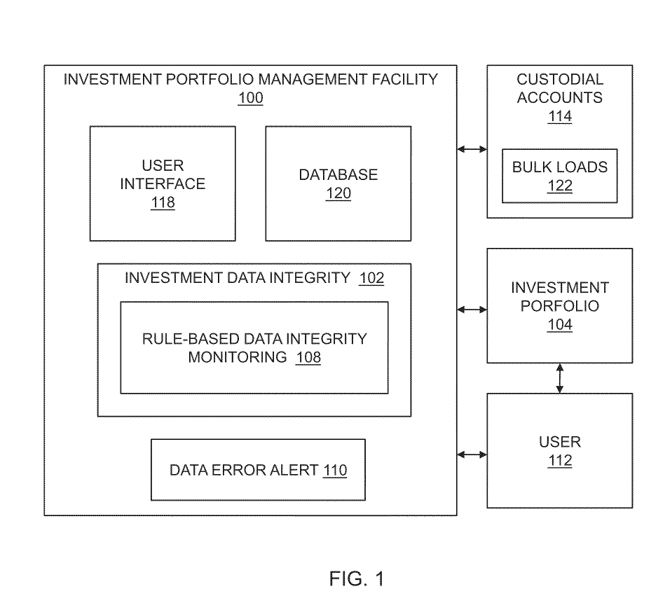

Referring to FIG. 1, the present disclosure may provide for a computer-implemented method of investment portfolio management. The investment portfolio management facility 100 may be rule-based, object oriented, event model-based and the like, among other features, characteristics and capabilities. The investment portfolio management facility 100 may maintain investment data integrity 102 for investment portfolios 104, such as through rule-based data integrity monitoring 108, where an investment data error found as a result of the data integrity monitoring 108 could cause monetary impact to an investment portfolio 104 if uncorrected. Investment data integrity monitoring 108 may be accomplished by a rule-based, computer-implemented module, which may be a self-contained module or may contain code disposed across multiple computers. An investment data error alert 110 may be provided to a user 112 of the investment portfolio management facility 100 when investment data errors are identified by the data integrity monitoring 108, and the investment data error may be corrected upon user direction to do so. In embodiments, a user 112 may be made aware of an error through a plurality of user interfaces 118, tools, alerts 110, and the like, in such a way as to be part of a user's normal portfolio activity, and thus provide the user an improved visibility to errors in their portfolio 104. The user interface 118 may include an account list, an errors and alerts tool window, a data edit bar, and the like. In embodiments, error and alert implementation may be implemented as part of a business object and/or event model, bulk loading 122 with database 120 stored procedures, and the like. Errors and warnings may include a custodial balance error as associated with a custodial account 114, double entry error, fee tier gap, fee tier internal inconsistency, fee tier overlap, fee tier missing, invalid phone number warning, invalid name warning, oversold units, settle data before trade date, trade amount mismatch error, zero shares error, zero price error, zero amount error, and the like.

Errors and alerts may be implemented in different aspects of the portfolio, such as in an event model of the system; on a database when performing bulk imports of prices, custodial balances, and transaction activities; and the like. The process flow for the different implementations models may slightly different. To correctly create a business rule, multiple models may need to be implemented, such as both in the event model of the system and on the database. While the following description is centered on two embodiment implementations of the business object and/or event model and on the database performing bulk imports, it will be appreciated by one skilled in the art that other implementations are within the scope of the present disclosure.

In embodiments, the present disclosure may provide an object and/or event model, where the business rules and errors and alerts interact and include all or a portion of the following steps:
1. A business rule monitors specific properties on specific business entities.
2. When a business entity changes in such a way that causes problems, the business rule may create the appropriate alert and attach that alert to the business entity that caused the problem.
3. If a business entity is saved while there are alerts attached, the alerts may be saved in the database attached to the business entity.
4. Once an alert has been attached to a business entity, users see the alert in one of three user interface areas. These areas may include:
   a. A list screen with an error count, warning count, information count and combined column, and the like.
   b. An errors and alerts tool window displaying alert detail about any selected business entities, such as in a main document pane. It may display alert details for list screens as well as business entity edit screens.
   c. Business entity edit screens may have an edit bar that displays error/warning/information totals in real-time.
5. The business rule monitors business entities with errors.
6. When the conditions that caused a particular alert to be created are corrected, the business rule deletes the relevant alert from the business entity.
7. When a business entity is saved after alerts have been deleted, the alerts saved in the database may also be removed.

In embodiments, one business rule may create or delete multiple alerts. Different alerts may have different properties, and may include the following properties: business entity; alert type; created date; effective date; description; and the like.

In embodiments, the present disclosure may provide error alerts and warnings associated with bulk loading of data into the system, such as into a database. When bulk-loading data into the system, it may be necessary to bypass the system's event model for certain high-volume business entities. To maintain the integrity of the errors and alerts, the business rules may be duplicated in stored procedures that run quickly on bulk data already saved in the database. In an example, the process may include the following steps:
1. The system bulk imports a block of data using a unique Batch ID for business objects, such as for transaction activities, custodial balances, prices, and the like.
2. A rule runs a stored procedure using the Batch ID. The rule looks at data stored in the database. Depending on the state of the saved data, different results may occur, such as:
   a. If the saved data doesn't match the requirements of the rule, an alert will be created and saved in the database.
   b. If the saved data matches the requirements of the rule, any existing alerts will be deleted from the database.

In embodiments, any alerts created by the stored procedure may be viewed by user interface tools.

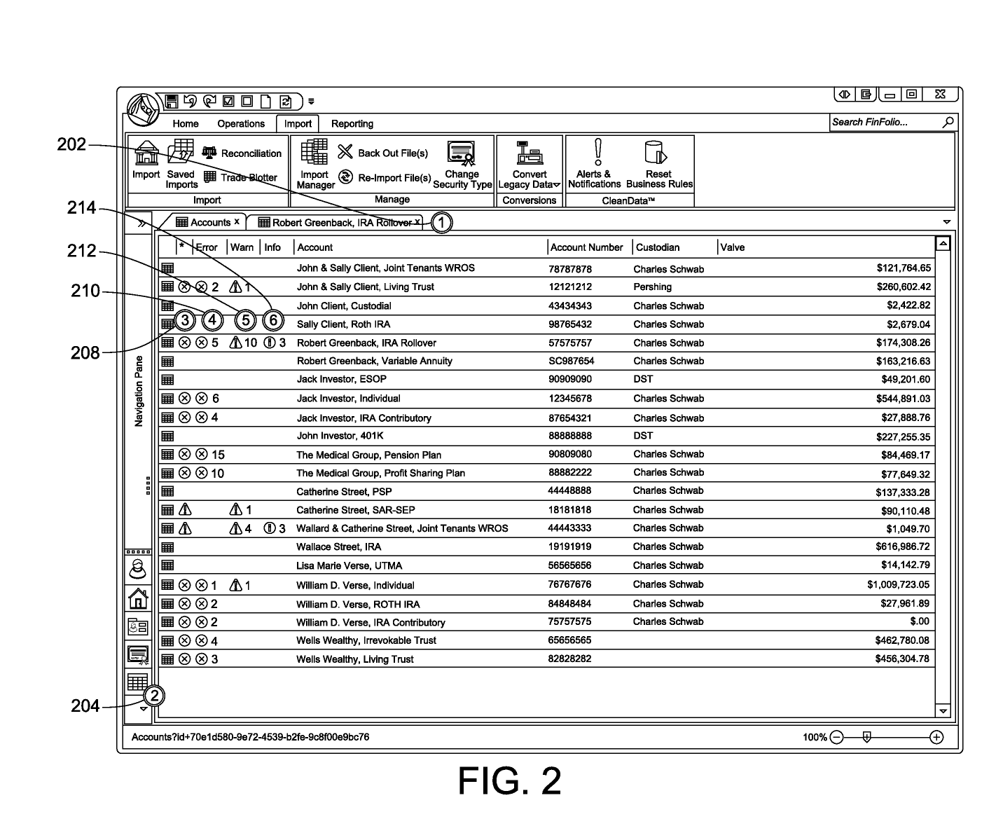

In embodiments, the present disclosure may include a user interface, such as including an account list screen, errors and alerts tool window, edit bar, and the like. FIG. 2 shows an embodiment of a main account list. The list as shown has four columns that show the error/warning/info status of each account. Each column may be turned on or off by the user. The account list shown is an example of how error and alert statuses may be shown for all item lists in system. This example shows the following possible elements in such an account list:
1. Main Document Pane 202—The main document area may hold all user working documents, such as with one displayed at a time. Documents may be item lists, edit screens, operations tools, and the like.
2. List Accounts Button 204—a user may click the list accounts button to display the current list of accounts.
3. “Worst Problem” Column 208—This may show the symbol of the worst type of problem associated with this item. Examples:
   a. “Robert Greenback, IRA Rollover” has errors, warnings and information items. Errors may take precedent over everything else, so the error symbol is displayed in this example.
   b. “Willard & Catherine Street, Joint Tenants WROS” has warnings and information items. Warnings may take precedent over information items, so the warning symbol is displayed in this example.
4. Total Error Column 210—Shows the total number of errors for the account.
5. Total Warnings Column 212—Shows the total number of warnings for the account.
6. Total Information Column 214—Shows the total number of information items for the account.

In embodiments, other information may be displayed, such as a ‘multi-select’ function, where more than one account may be selected at a time, and may cause all errors/warning/info to be displayed for all selected items. An ‘all lists have error information’ function, where all system lists have error and warning information displayed as optional columns in the list. In embodiments, although FIG. 2 shows an account List, other screens may have the same error columns displayed, such as a household list, a portfolio list, a client list, a model list, a fee schedule list, a billable items list, a rebalance items list, and the like.

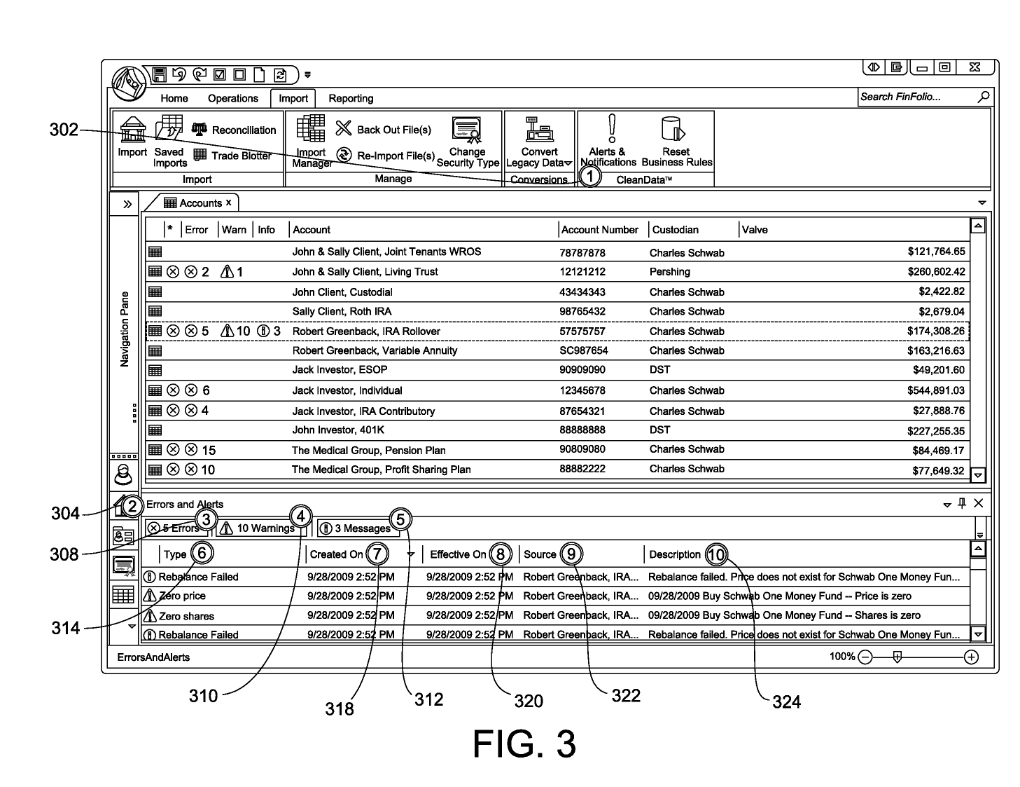

FIG. 3 shows an embodiment of an errors and alerts tool window beneath the main account list. In embodiments, the errors and alerts tool window may display beneath any list of items in the system. It may also display beneath edit items, operations tools, and the like. It may allow users, such as from any screen, to view detailed information about problems that exist with a particular data item. This example shows the following possible elements in such an errors and alerts tool window:
1. Alerts & Notifications Button 302—The user may click this button to display the Errors and Alerts tool window.
2. Errors and Alerts Tool Window 304—This tool window shows error and alert information about selected items in the main document pane.
3. Error Count Button 308—Shows the number of errors for the selected item or items. The user may click this button and cause it to become selected and unselected. When the error button is selected, errors will display in the tool window. When unselected, they will not.
4. Warning Count Button 310—Shows the number of warning for the selected item or items. The user may click the button and cause it to become selected and unselected. When the warning button is selected, warnings will display in the tool window. When unselected, they will not.
5. Information Item Count Button 312—Shows the number of information items for the selected item or items. The user may click the button and cause it to become selected and unselected. When the information items button is selected, information items will display in the tool window. When unselected, they will not.
6. Type 314—Lists the alert type.
7. Created On 318—Lists the date the alert was created on.
8. Effective On 320—Lists the date the alert is relevant.
9. Source 322—Lists the source of the error. (In this example, the source is the account.)
10. Description 324—Lists a detailed description of the error/warning/info item.

In embodiments, other information may be displayed, such as a ‘multi-threaded function’ for when a user selects one or more accounts or other data items. Other examples include: an errors and alerts tool window that loads the related error and alert information without “locking up” the main application; a ‘real-time display’ function, when accounts and other data items are being edited, the errors and alerts tool window shows problems with the data item in real-time—as errors/alerts are created or fixed in the edit screen, the Errors and Alerts Tool Window may show the current status. In addition, double-clicking an error/warning/info in the Errors and Alerts Tool Window may act to open the affected item for editing, right-clicking an error/warning/info in the Errors and Alerts Tool Window may display a menu, allowing them to open one or more items related to the error and alert; and the like.

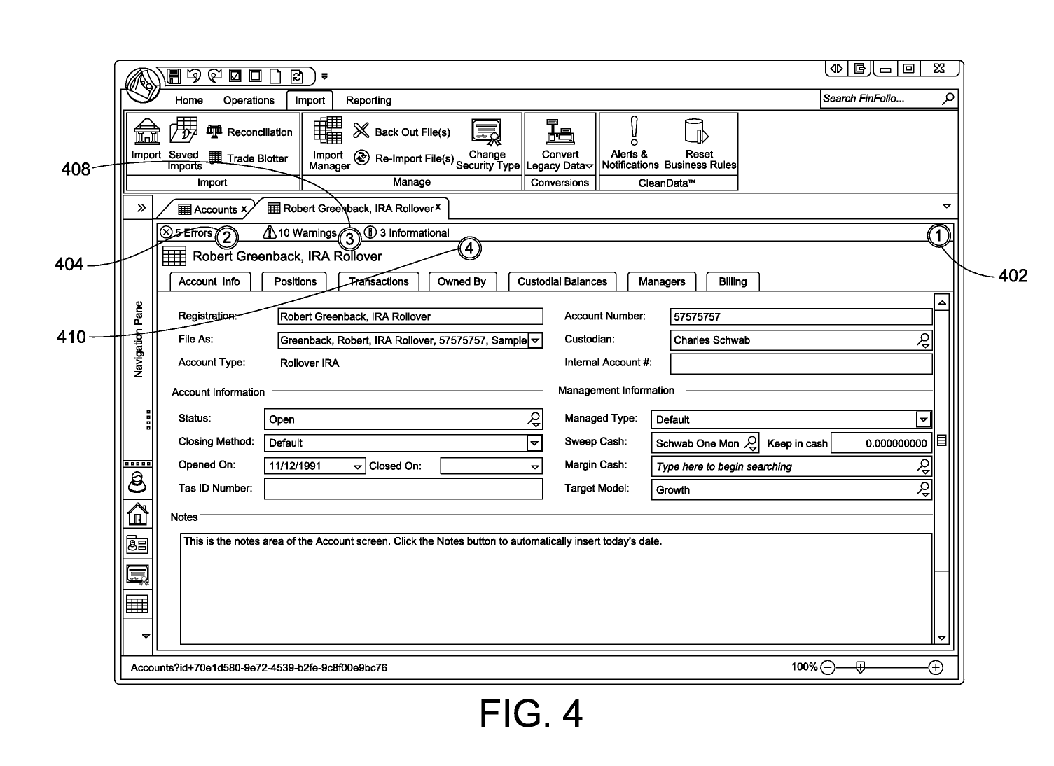

FIG. 4 shows an embodiment of an edit bar that may be included at the top of selected screens, such as edit screens. It shows user errors and alerts for the item as it is edited in real time. This example shows the following possible elements in such an edit bar:
1. CleanData Edit Bar 402—The band at the top of the edit item may be made distinctive, such as by coloring the band to highlight its function.
2. Error Count 404—Shows the current number of errors for this item.
3. Warning Count 408—Shows the current number of warnings for this item.
4. Info Count 410—Shows the current number of information items for this item. In addition, double-clicking the edit bar may open the errors and alerts tool window.

Some embodiments may provide for customizing errors and alerts, where users may be allowed to extend the errors and alerts. For example, users may be able to extend errors and alerts in Microsoft Visual Studio.NET. To extend the system, a user may create a custom business rule, a custom alert, and the like. For instance, users may cause their custom business rule to monitor properties on business entities as described herein. Their custom business rule may create custom alerts to notify users of the problem they are monitoring.

Embodiments provide for a plurality of error messages and warnings, such as custodial balance error, double entry error, fee tier gap, fee tier internal inconsistency, fee tier overlap, fee tier missing, invalid phone number warning, invalid name warning, oversold units, settle data before trade date, trade amount mismatch error, zero shares error, zero price error, zero amount error, and the like.

Some embodiments provide for protection against custodial balance errors, where the system tracks accounts and compares the position unit balance each day to the balances that come from the custodian. When they don't match, this error is created. This is a serious error that can occur and should be fixed immediately. Out of Balance errors indicate serious problems with transactions on the day of the error. It may mean there are missing activities or that activities have been entered on the wrong day. Anything transaction-related that affects a customer's unit values can cause this error, including missing transactions, incorrect values in transaction unit fields, incorrect trade dates, incorrectly coded transactions (coding a Dividend Reinvest as a Dividend), Incorrect custodial balances, and the like. This may affect every calculation or data point in the system, depending on the specific activities that are missing or miscoded. It will always affect calculations that rely on unit values, including unit values, market values, and other like calculations.

If the custodial balances are correct, which is usually the case, account activities must be changed so that they yield the correct balance on the day of the error. This can be done by checking custodial statements or calling the custodian to verify every trade on the day in question. Once the activities are corrected, the balance will update to match the custodial share balance. If the custodial balance is incorrect, the custodial balance can be changed to match the position balance. In an example, suppose a new account was begun with an initial cash deposit, and then bought a position in Microsoft. Their account activities are missing the offsetting sell from the CASH position for the Microsoft purchase. The CASH position should be $800 after making the purchase, but has been recorded as $1,000 since there is no record of the $200 sell from CASH to fund the $200 Microsoft purchase. This scenario is depicted as follows:

Activities

| | | | | | Running |
|---|---|---|---|---|---|
| Security | Date | Activity | Units | Dollars | Balance |
| CASH | Jan. 1, 2008 | Deposit | 1,000.000 | $1,000.00 | 1,000.000 |
| Microsoft | Jan. 2, 2008 | Buy | 30.000 | $200.00 | 30.00 |
| (MSFT) | | | | | |

Custodial Balances

| | | Custodial |
|---|---|---|
| Security | Date | Balance |
| CASH | Jan. 1, 2008 | 1,000.000 |
| CASH | Jan. 2, 2008 | 800.000 |
| Microsoft | Jan. 2, 2008 | 30.000 |
| (MSFT) | | |

To fix this problem, the offsetting cash purchase must be created. Creating a new Sell in the CASH position for $200 on Feb. 1, 2008 will bring the running balance to $800 to match the custodial balance. At that point the error will be cleared, as depicted here:

| | | | | | Running |
|---|---|---|---|---|---|
| Security | Date | Activity | Units | Dollars | Balance |
| CASH | Jan. 1, 2008 | Deposit | 1,000.000 | $1,000.00 | 1,000.000 |
| CASH | Jan. 2, 2008 | Sell | 200.000 | $200.00 | 800.000 |
| Microsoft | Jan. 2, 2008 | Buy | 30.000 | $200.00 | 30.00 |
| (MSFT) | | | | | |

Some embodiments may provide for protection against double entry errors, where the system tracks account activities and ensures that every transaction is associated with the proper offsetting double entry bookkeeping transaction. Double Entry bookkeeping errors may not be seen in a share and cash balance reconciliation. If overlooked, they can cause data issues in performance freporting, tax reporting and other areas of the system. This may be caused by any activity that is posted to the system without the proper offsetting bookkeeping transaction, such as a Buy of a security without the Sell out of CASH, a Sell of a security without the Buy of CASH, incorrect (different) trade dates for the related transaction and its associated offset, incorrectly coded transactions that do not have the correct offset transaction, and the like. This can affect multiple calculations or data points in the system which can result in inaccuracies, such as sweep CASH balance, performance calculations and reporting, tax calculations and reporting, and the like.

If there is a Double Entry error from the system, one needs to investigate the activities that took place on the date of the error in the system along with activities of the custodian. When the error is found, one will need to adjust an existing activity that was miscoded or add the appropriate activity to create the proper bookkeeping entry. Common errors may include Buys without the offsetting CASH Sell, Sells without the offsetting CASH Buy, and the like. In an example, suppose a Buy activity of Microsoft was posted to the system without an offsetting Sell of the CASH sweep for an account, such as depicted as follows:

| Security | Date | Activity | Price | Units | Amount |
|---|---|---|---|---|---|
| Microsoft (MSFT) | Jan. 2, 2008 | Buy | 35.22 | 100 | $3522.00 |

The offsetting CASH Sell must be created. Creating a new Sell in the CASH position for $3522.00 on Jan. 2, 2008 will correct the Double Entry bookkeeping error:

| Security | Date | Activity | Price | Units | Amount |
|---|---|---|---|---|---|
| CASH | Jan. 1, 2008 | Sell | 1.000 | 3522 | $3522.00 |
| Microsoft | Jan. 2, 2008 | Buy | 35.220 | 100 | $3522.00 |
| (MSFT) | | | | | |

In another example, a Dividend Reinvest transaction was incorrectly posted as a Buy. The Double Entry error was triggered because the Buy did not have an associated Sell of CASH. After comparison with the custodial statement, the user noticed that the Buy should have been a Dividend Reinvest transaction.

| Security | Date | Activity | Price | Units | Amount |
|---|---|---|---|---|---|
| DODFX | Mar. 17, 2008 | Buy | 39.09 | 3 | $117.27 |

The activity transaction code should be changed from a Buy to a Dividend Reinvest:

| Security | Date | Activity | Price | Units | Amount |
|---|---|---|---|---|---|
| DODFX | Mar. 17, 2008 | Div. Reinvest | 39.09 | 3 | $117.27 |

Some embodiments may provide for protection against a fee tier gap, where each Fee Schedule must have fee tiers that cover every dollar amount in the fee schedule, such as up to $999,999,999.00 for each asset class. When there is a gap between two fee tiers, the Fee Tier Gap error is created. Several problems will trigger this error, such as: the High amount for a fee tier is less than the Low amount for the next-highest fee tier; the Low amount for the smallest fee tier is greater than zero; or the High amount for the highest fee tier is less than $999,999,999.00, if any of the prior problems occur within a specified class, and the like. Note that the most common cause of the Fee Tier Gap error may be when the High amount for the largest fee tier bracket does not equal a set amount, such as the $999,999,999.99. In this example, the highest amount for the highest fee tier bracket should be $999,999,999.00 for every single fee schedule. Fee Tier Overlap may not affect performance calculations but does prevent one from billing the accounts. This problem can be eliminated by adjusting the fee tiers to eliminate any gaps. For instance, make sure the High amount of the highest fee tier is set to $999,999,999.99.

Some embodiments may provide for protection against fee tier internal inconsistencies. A Fee Tier Internal Consistency alert may be raised whenever there are internal problems with fee tier brackets. This can happen if the low value is higher than the high value, if the user entered a negative percentage for the fee amount, and the like. Note that if multiple fee tier brackets have problems, only one Fee Tier Internal Consistency alert may be created. In embodiments, all bracket problems may need to be fixed before the alert disappears. Fee Tiers can be caused by a number of problems, such as a Low bracket amount equal to or higher than the High bracket amount, a bracket percentage less than 0%, a bracket percentage greater than 100%, and the like. Note that 0% may be considered a valid amount for the fee tier bracket percentage, and as such, would not create an alert. Fee Tier Internal Consistency may not affect performance calculations but does prevent one from billing the accounts. This alert may be eliminated by fixing all problems in all fee tiers for the affected fee schedule. In embodiments, as long as one fee tier has a problem, the alert may remain.

Some embodiments may provide for protection against a Fee Tier Overlap, where each Fee Schedule must have fee tiers that cover every dollar amount in the fee schedule up to a predetermined amount, such as $999,999,999.00 for each asset class. When two fee tiers overlap, the Fee Tier Overlap error is created. Several situations can cause this error, such as when a fee tier for a particular class overlaps with another fee tier for the same class, when a fee tier for a particular class overlaps with a fee tier for all classes, when two fee tiers for all classes overlap, and the like. Fee Tier Overlap does may not affect performance calculations but does prevent one from billing one's accounts. This problem may be eliminated by adjusting fee tiers to eliminate any overlap.

Some embodiments may provide for protection against an invalid phone number warning, where the system triggers a warning message if a Phone Number associated with a client does not follow a predetermined format, such as:

(xxx) xxx-xxxx

+x (xxx) xxx-xxxx

xxx-xxxx

(xxx) xxx-xxxx ext. xxx

The Phone Number warning may be caused by incomplete numeric information or invalid phone number format. This can affect the integrity of stored phone number information in the system. The Warning may be used as a signal to take a deeper look at the phone number information that is populated in the system. Changing incorrect formats and filling in missing data can resolve the warning.

Some embodiments may provide for protection against an Invalid Name Warning, where the system triggers a warning message if the entity does not have the proper Name information for Client, Account, Security, Household and Portfolio entities, and the like. Often times the custodial information received may not correctly interpret the name of the entity or the user may forget to complete a required field in the system such as “File As ______.” This Warning helps to keep the system of records clean. Incomplete entity information may include missing first or last name, missing File As field, no name of Business (for a business titled account), if the Security name is the same as the ticker/symbol, and the like. This can occur if the security was set up from a download without all of the necessary descriptive information. This can affect the integrity of descriptive information on reports and in the system. Incomplete File As information can make it difficult to locate entity data. The Warning may be used as a signal to take a deeper look at the descriptive information that is populated in the system. Changing incorrect formats and filling in missing data may resolve the warning.

Some embodiments may provide for protection against Oversold Units. It is impossible to sell more units of a security than are owned. If you oversell a position in one of the accounts, the Oversold Units alert will be created to notify the user of the problem. Selling a position short does not trigger the Oversold Units alert. The alert is only created when one oversells a long position, regardless of whether one holds a short position. The Oversold Units alert will be created any time one holds negative shares in a long position. This may be caused by: incorrectly recording a sell for the wrong position; a trade in the oversold position is incorrect; one is missing Buy, Dividend Reinvest or other trades in this position that open new tax lots, and the like. The missing activities may occur before the activity that makes one's unit balance negative. Having an oversold position is a very serious problem that can affect every calculation or data point in the system including reconciliation with custodial balances. It is not possible to oversell a long position. The incorrect or missing trades must be found and the problems fixed in the account transaction blotter.

Some embodiments may provide for protection against a Settle Date Before Trade Date issue. When a Settle Date is recorded for a trade, it must happen after the Trade Date. If the Settle Date is recorded before the Trade Date, the Settle Date Before Trade Date error is created. This error occurs when the Settle Date of a trade occurs before the Trade Date. Note that if the Settle Date has not been recorded, this error will not be created. If the Trade Date has been recorded incorrectly, the problem can affect every calculation in the system. If the Settle Date has been recorded incorrectly, the effect may be much smaller in scope. When this error has occurred, either the Trade Date or Settle Date has been recorded incorrectly, or contacting the custodian may be necessary to determine which date should be changed.

Some embodiments may provide for protection against a Trade Amount Mismatch Error, where the system monitors the integrity of all Trade transaction activities and compares the units, the price, and the amount (including commission and fees) and ensures that the results of the trade are mathematically correct. For example, this error may result whenever the following formula fails for a Trade: Amount=(Units×Price)+Commission. The Trade Amount Mismatch Error may allow for a $0.01 margin of error in the price field, to allow for rounding issues. This error indicates potentially serious problems with the Trade transactions on the day of the error. Custodial data can either be reported incorrectly or the decimal precision of either units or price can be incorrect with the system. This may be caused by any component of a Buy or Sell transaction that causes the computed Amount value to differ from the Amount in the system, such as incorrect Price, incorrect Units, incorrect Amount field, incorrect Commission field, incorrect decimal precision (rounding, truncating) of price, unit, amount or commission fields, and the like. The effect on the calculations depends on which field is incorrect in the trade. It can range from having no effect whatsoever to affecting every calculation or data point in the system including reconciliation with custodial balances. The Error message may be used as a signal to drill into the system where the Error is present. Research the transaction and correct as necessary. Once the data of the transaction is corrected, the Error message may be resolved.

Some embodiments may provide for protection against a Zero Shares Error, where the system triggers an Error message if a transaction in the system is missing the Units field and the Units field is a required field for the transaction type. Often times the custodial information received may not be correctly populated for all types of transactions. This Error notification is intended to provide the user with an error message indicating the Units field is missing for a transaction. This error may be caused where the Units Field is required by the transaction type, but the Units Field is missing. This can affect the integrity of data in performance calculations, billing, reporting and other calculations if not promptly fixed. The Error message may be used as a signal to drill into the system where the important piece of data is missing. Research the missing data point and populate it in the system. Once the missing piece of data is populated in the system, the Error message will be resolved.

Some embodiments may provide for protection against a Zero Price Error, where the system triggers an Error message if a transaction in the system is missing the Price field and the Price field is a required field for the transaction type. Often times, the custodial information received may not be correctly populated for all types of transactions. This Error notification is intended to provide the user with an error message indicating the Price field is missing for a transaction, and may be caused where the Price Field is required by the transaction type, but the Price field is missing. This can affect the integrity of data in performance calculations, billing, reporting and other calculations if not promptly fixed. The Error message may be used as a signal to drill into the system where the important piece of data is missing. Research the missing data point and populate in the system. Once the missing piece of data is populated in the system, the Error message will be resolved.

Some embodiments may provide for protection against a Zero Amount Error, where the system triggers an Error message if a transaction in the system is missing the Amount field and the Amount field is a required field for the transaction type. Often times, the custodial information received may not be correctly populated for all types of transactions. This Error notification is intended to provide the user with an error message indicating the Amount field is missing for a transaction, and may be caused where the Amount field is required by the transaction type, but the Amount field is missing. This can affect the integrity of data in performance calculations, billing, reporting and other calculations if not promptly fixed. The Error message may be used as a signal to drill into the system where the important piece of data is missing. The user may then research the missing data point and populate in the system. Once the missing piece of data is populated in the system the Error message will be resolved.

Referring again to FIG. 1, an embodiment maintains data integrity in a rule-based investment portfolio management system 100. The investment portfolio management system 100 may be object oriented and/or event model based. Some embodiments may provide for a computer-implemented method and system, including an event model investment portfolio management facility 100 maintaining investment data integrity 102 for at least one of a plurality of investment portfolios 104 in the investment portfolio management facility 100 through rule-based data integrity monitoring 108. This may be accomplished by a rule-based data integrity monitoring facility, such as a computer-based module, where an investment data error found as a result of the data integrity monitoring 108 would cause monetary impact to the at least one investment portfolio 104 if uncorrected. The investment portfolio management facility may provide an investment data error alert 110 to a user 112 of the investment portfolio management facility 100 when investment data errors are identified by the data integrity monitoring 108, and correcting the investment data error upon user direction to do so, thus transforming the data structures that enable the portfolio management system from an erroneous state to a corrected state. In embodiments, the investment portfolio management facility may provide for specific errors and warnings, and may transform a portfolio from an erroneous state to a corrected state for such errors and warnings. These may include custodial balance errors associated with a custodial account 114, double entry error, fee tier gap, fee tier internal inconsistency, fee tier overlap, fee tier absence, invalid phone number warning, invalid name warning, oversold units, settle date before trade date, trade amount mismatch error, zero shares error, zero price error, zero amount error, and the like. In addition, the system may provide for simultaneous presentation of data on a user interface 118 and in a database 120.

An embodiment maintains data integrity investment portfolio management system 100 through correction of embedded data errors in bulk loading imports to the investment portfolio management system database 120. The investment portfolio management system 100 may be rule-based, object oriented, event model-based, and the like, among other features, characteristics and capabilities. Some embodiments may provide for a computer-implemented method, comprising an event model investment portfolio management facility maintaining investment data integrity 102 for bulk data loads from custodial accounts to at least one of a plurality of investment portfolios 104 in the investment portfolio management facility through rule-based data integrity monitoring, wherein an investment data error found as a result of the data integrity monitoring would cause monetary impact to the at least one investment portfolio if uncorrected. The investment portfolio management facility may provide an investment data error alert 110 to a user of the investment portfolio management facility when investment data errors are identified in the bulk loads 122 by the data integrity monitoring, and correcting the investment data error upon user direction to do so. In embodiments, the investment portfolio management facility may provide for specific error and warnings, such as custodial balance error, double entry error, fee tier gap, fee tier internal inconsistency, fee tier overlap, fee tier missing, invalid phone number warning, invalid name warning, oversold units, settle date before trade date, trade amount mismatch error, zero shares error, zero price error, zero amount error, and the like.

An embodiment provides for a user interface 118 for visualizing data errors contained in a rule-based investment portfolio management system 100. The investment portfolio management system 100 may be object oriented, event model based, and the like. Visualization of alerts 110 and notifications may be provided on an account list, an errors and alerts tool window, a data edit bar, and the like. In addition, the system may provide for simultaneous presentation of data on a user interface 118 and in a database 120. Some embodiments may provide for a computer-implemented method, comprising an event model investment portfolio management facility maintaining investment data integrity 102 for at least one of a plurality of investment portfolios 104 in the investment portfolio management facility through rule-based data integrity monitoring, where an investment data error found as a result of the data integrity monitoring would cause monetary impact to the at least one investment portfolio if uncorrected. The investment portfolio management facility may providing a graphical user interface 118 for visualizing investment data error alert 110 to a user of the investment portfolio management facility when investment data errors are identified by the data integrity monitoring, and a visual correcting mechanism for correcting the investment data error upon user action with the graphical user interface 118. The visual correcting mechanism may be provided on an account list as presented through the graphical user interface 118, an error and alert edit bar as presented through the graphical user interface 118, a error edit bar as presented through the graphical user interface 118, and the like. In embodiments, the investment portfolio management facility may provide for specific error and warnings, such as custodial balance error, double entry error, fee tier gap, fee tier internal inconsistency, fee tier overlap, fee tier missing, invalid phone number warning, invalid name warning, oversold units, settle date before trade date, trade amount mismatch error, zero shares error, zero price error, zero amount error, and the like.

An embodiment may provide for user customization of error detection rules in a rule-based investment portfolio management system 100. The investment portfolio management system 100 may be object oriented, event model based, and the like. Embodiments may provide for a computer-implemented method, including an event model investment portfolio management facility that maintains investment data integrity 102 for at least one of a plurality of investment portfolios 104 in the investment portfolio management facility through rule-based data integrity monitoring, where an investment data error found as a result of the data integrity monitoring would cause monetary impact to the at least one investment portfolio if uncorrected. The investment portfolio management facility may provide a user rule customization framework that enables a user of the investment portfolio management facility to create custom rules for data integrity monitoring to meet user-specific needs. An investment data error alert 110 may be provided to the user of the investment portfolio management facility when investment data errors are identified by the data integrity monitoring, and correcting the investment data error upon user direction to do so. In embodiments, the investment portfolio management facility may provide for specific error and warnings, such as custodial balance error, double entry error, fee tier gap, fee tier internal inconsistency, fee tier overlap, fee tier missing, invalid phone number warning, invalid name warning, oversold units, settle date before trade date, trade amount mismatch error, zero shares error, zero price error, zero amount error, and the like.

The methods and systems described herein may be deployed in part or in whole through a machine that executes computer software, program codes, and/or instructions on a processor. An embodiment may be implemented as a method on the machine, as a system or apparatus as part of or in relation to the machine, or as a computer program product embodied in a computer readable medium executing on one or more of the machines. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of this disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the present disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like.

Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the present disclosure has been made in connection with the embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

All documents referenced herein are hereby incorporated by reference.

What is claimed is:

1. A computer-implemented system including a program stored on a computer-readable medium, comprising;
an event model for an investment portfolio management facility stored as a data structure on a computer-readable medium;
a rule-based data integrity monitoring module for maintaining investment data integrity for at least one of a plurality of investment portfolios in the investment portfolio management facility, wherein an investment data error found by the data integrity monitoring module would cause monetary impact to the at least one investment portfolio if uncorrected; and
an investment data error alert facility associated with the event model for providing an alert to a user of the investment portfolio management facility when investment data errors are identified by the data integrity monitoring module.

2. The computer-implemented system of claim 1, wherein the data integrity monitoring module is a self-contained module.

3. The computer-implemented system of claim 1, wherein the data integrity monitoring module is distributed across a plurality of computer facilities.

4. The computer-implemented system of claim 1, wherein the investment data error is corrected upon user direction to the investment portfolio management facility.

5. The computer-implemented system of claim 4, wherein the user direction is provided through a graphical user interface.

6. The computer-implemented system of claim 1, wherein the investment data error is at least one of a custodial balance error as associated with a custodial account, double entry error, fee tier gap error, fee tier internal consistency error, fee tier overlap error, fee tier missing error, invalid phone number, invalid name, oversold units error, settle data before trade date error, trade amount mismatch error, zero shares error, zero price error, and zero amount error.

7. The computer-implemented system of claim 1, wherein the alert to the user is through a graphical user interface provided by the investment portfolio management facility in such a way that the alert is provided as a normal part of a user's normal portfolio activity.

8. The computer-implemented system of claim 7, wherein the alert is provided as part of an account list user interface.

9. The computer-implemented system of claim 7, wherein the alert is provided as part of an errors and alerts user interface.

10. The computer-implemented system of claim 7, wherein the alert is provided as part of a business entity user interface.

11. The computer-implemented system of claim 1, wherein the rules, errors, and alerts interact within the investment portfolio management facility.

12. The computer-implemented system of claim 1, wherein the alert has a property.

13. The computer-implemented system of claim 12, wherein the property is at least one of a business entity, alert type, creation date, and effective date.

14. The computer-implemented system of claim 1, wherein the user is provided with a rule customization framework that enables the user of the investment portfolio management facility to create custom rules for data integrity monitoring to meet user-specific needs.

15. The computer-implemented system of claim 1, wherein the user is allowed to customize at least one of the rule, the error and the alert.

16. The computer-implemented system of claim 1, wherein an event provided to the portfolio management facility is provided as the result of an error found during a bulk import of data.

17. The computer-implemented system of claim 17, wherein the bulk import of data is to a database.

18. The computer-implemented system of claim 17, wherein the data is at least one of price data, custodial balance data, and transaction activity data.

19. The computer-implemented system of claim 17, wherein an event provided to the portfolio management facility is provided as the result of an error found in a previously imported bulk import of data.

20. A method, comprising;
providing an event model for an investment portfolio management facility including a rule-based data integrity monitoring module and an investment data error alert facility;
maintaining investment data integrity through the data integrity monitoring module for at least one of a plurality of investment portfolios in the investment portfolio management facility, wherein an investment data error found by the data integrity monitoring module would cause monetary impact to the at least one investment portfolio if uncorrected; and
providing an alert to a user of the investment portfolio management facility through the investment data alert facility when investment data errors are identified by the data integrity monitoring module.
